(19) United States
(12) Patent Application Publication
(10) Pub. No.: US 2016/0168020 A1
(43) Pub. Date: Jun. 16, 2016

(54) METHOD OF FINISHING PRE-POLISHED GLASS SUBSTRATE SURFACE

(71) Applicant: Asahi Glass Company, Limited, Chiyoda-ku (JP)

(72) Inventors: Yuzo OKAMURA, Tokyo (JP); Yusuke HIRABAYASHI, Tokyo (JP); Yoshiaki IKUTA, Tokyo (JP)

(73) Assignee: Asahi Glass Company, Limited, Chiyoda-ku (JP)

(21) Appl. No.: 14/955,526

(22) Filed: Dec. 1, 2015

(30) Foreign Application Priority Data
Dec. 12, 2014 (JP) 2014-251922
Aug. 10, 2015 (JP) 2015-158240

(51) Int. Cl. C03C 15/02; B24B 37/04; C03C 3/076; C03C 25/70; C03C 3/06

(52) U.S. Cl. CPC C03C 15/025; C03C 25/70; C03C 3/06; C03C 3/076; B24B 37/044; C03C 2201/42

(57) ABSTRACT

The present invention relates to a method of finishing a pre-polished TiO₂—SiO₂ glass substrate, containing a step of measuring a striae-originated MSFR (MSFR₀) of a major surface, a step of measuring a TiO₂ concentration distribution (ΔTiO₂) in the major surface, a first and second processing steps of processing the major surface, and a cleaning step of cleaning the major surface, in which according to the MSFR₀ (nm) and the ΔTiO₂ (wt %), the total etching amount (nm) of a chemical etching amount of the major surface in the second processing step and another chemical etching amount of the major surface in the cleaning step is controlled to satisfy the following expression (1)

Total etching amount≦(10 nm−MSFR₀)v/A/ΔTiO₂ (1)

(v is an average etching rate (nm/sec) and A is an TiO₂ concentration dependency (nm/sec/wt %) of an etching rate).

### TECHNICAL FIELD

The present invention relates to a method of finishing a pre-polished glass substrate surface. More specifically, the present invention relates to a method of, after pre-polishing, finishing a surface of a quartz glass substrate containing SiO₂ as a main component and TiO₂ as a dopant, which is used for applications requiring very high surface smoothness, particularly, for a base material of a reflective mask or mirror employed at the time of lithography using EUV (Extreme Ultra-Violet) light, a base material of a magnetic recording medium, or a base material of a nanoimprint lithography mold. The quartz glass substrate containing SiO₂ as a main component and TiO₂ as a dopant is hereinafter referred to as “TiO₂—SiO₂ glass”, the lithography using EUV light is hereinafter simply referred to as “EUVL”, and the base material of a reflective mask or mirror employed at the time of EUVL is hereinafter referred to as “EUVL base material”, in this description.

The present invention also relates to a TiO₂—SiO₂ glass substrate having very high surface smoothness.

### BACKGROUND ART

In the semiconductor production process, an exposure apparatus for transferring a fine circuit pattern onto a wafer to produce an integrated circuit has been conventionally widely used. Along with the recent trend toward high integration and high functionality of a semiconductor integrated circuit, the integrated circuit becomes increasingly miniaturized. Therefore, a glass substrate for an optical base material used in a photomask of an exposure apparatus is required to have high-level flatness and smoothness so as to exactly form a circuit pattern image on a wafer surface.

Furthermore, under such a technical trend, a lithography technique using EUV light (i.e., EUVL technique) as a next-generation exposure light source is considered to be applicable over the 20-nm and subsequent several generations and is therefore attracting attention. The EUV light indicates light having a wavelength band in a soft X-ray region or a vacuum ultraviolet region and, specifically, indicates light with a wavelength of approximately from 0.2 nm to 100 nm. As the lithography light source, use of light with a wavelength of 13.5 nm is being studied at present. The exposure principle of EUVL is the same as the conventional lithography in that a mask pattern is transferred by using a projection optical system. However, since there is no material capable of transmitting light in the EUV light energy region, a refractive optical system cannot be used and the exposure in the EUVL is compelled to use a reflective optical system. Thus, a reflective mask or a reflective mirror is employed (see, Patent Document 1).

The reflective mask for use in EUVL is fundamentally composed of (1) a base material, (2) a reflective multilayer film formed on the base material, and (3) an absorber layer formed on the reflective multilayer film. The reflective mirror is fundamentally composed of (1) a base material and (2) a reflective multilayer film formed on the base material.

As for the base material (EUVL optical base material) used for producing the reflective mask or reflective mirror, a material having a low thermal expansion coefficient is required so as to cause no distortion even under EUV light irradiation. Therefore, use of a glass substrate formed of a glass having a low thermal expansion coefficient is being studied. The glass substrate used as an EUVL optical base material is produced by polishing and cleaning the glass having a low thermal expansion coefficient with high degree of accuracy.

TiO₂—SiO₂ glass is known to be an ultralow thermal expansion material having a smaller thermal expansion coefficient than that of quartz glass, and in addition, the thermal expansion coefficient thereof can be controlled by the content of TiO₂ in the glass. Therefore, zero-expansion glass having a thermal expansion coefficient close to 0 can be obtained. On this account, it is being studied to use, as the EUVL optical base material, a glass substrate (TiO₂—SiO₂ glass substrate) prepared from a TiO₂—SiO₂ glass.

The TiO₂—SiO₂ glass substrate is produced by processing and cleaning a TiO₂—SiO₂ glass as a material thereof with high degree of accuracy. In the case of processing a TiO₂—SiO₂ glass substrate, the glass substrate is usually pre-polished at a relatively high processing rate until providing a glass substrate having a surface with predetermined flatness and surface roughness and thereafter, finished to provide a TiO₂—SiO₂ glass substrate having a surface with desired flatness and surface roughness by using a method with higher processing accuracy or employing processing conditions conducive to higher processing accuracy.

The TiO₂—SiO₂ glass is manufactured by hydrolyzing a titanium compound as a raw material of TiO₂ and a silicon compound as a raw material of SiO₂ in oxyhydrogen flame. At that time, it has been known that a variation in the TiO₂/SiO₂ composition ratio causes striped striae (see, e.g., Patent Document 2). Since mechanical and chemical properties of glass depend on the TiO₂/SiO₂ composition ratio, when TiO₂—SiO₂ glass having a non-uniform TiO₂/SiO₂ composition ratio is polished by a known method (e.g., the method described in Patent Document 3), the polishing rate becomes non-uniform in the glass surface, and an “undulation” with the same pitch as the striae pitch is generated in the TiO₂—SiO₂ glass. As a result, for example, the PV value of surface roughness in the spatial wavelength range of 50 μm to 2 mm inclusive of the pitch of the undulation becomes large. Therefore, it is difficult to finish the glass surface of such a TiO₂—SiO₂ glass after polishing to have ultrahigh flatness. Incidentally, the above-mentioned surface roughness is hereinafter referred to as “striae-originated MSFR” in the present description.

Then, there has been proposed a method where a local processing tool with the unit processing area being smaller than the major surface of a TiO₂—SiO₂ glass substrate to be processed is used for the finishing of the TiO₂—SiO₂ glass substrate surface, and the processing conditions of the TiO₂—SiO₂ glass substrate surface are set for each site of the TiO₂—SiO₂ glass substrate (see, Patent Documents 4 and 5). The method can prevent an undulation from newly occurring in the TiO₂—SiO₂ glass substrate surface at the time of finishing and can eliminate the likelihood of the undulation generated during pre-polishing growing at the time of finishing (see, Patent Documents 4 and 5).

The local processing tool used for the above-described purpose includes a tool employing, as the processing method, an ion beam etching method, a gas cluster ion beam (GCIB) etching method, a plasma etching method, a wet etching method, or a magnetic fluid (MRF (registered trademark)) polishing method, and a rotary small processing tool.

In the case of using a local processing tool for the finishing of the TiO₂—SiO₂ glass substrate surface, the surface roughness of the TiO₂—SiO₂ glass substrate surface after processing may deteriorate in some cases. Therefore, the TiO₂—SiO₂ glass substrate after the processing by a local processing tool is usually subjected to a second finishing for the purpose of improving the surface roughness. In the second finishing carried out for this purpose, chemical-mechanical polishing using a fine particle abrasive-containing polishing slurry and a polishing pad is usually employed. The polishing slurry is composed of a fine particle abrasive and a dispersion medium for the abrasive. In order to adjust the pH of the polishing slurry to a desired value, an acid or an alkali is usually used as the dispersion medium for the abrasive.

On the TiO₂—SiO₂ glass substrate surface after chemical-mechanical polishing, a fine particle abrasive sometimes remains Accordingly, the TiO₂—SiO₂ glass substrate surface after chemical-mechanical polishing is generally subjected to a wet-cleaning for the purpose of removing the abrasive remaining on the TiO₂—SiO₂ glass substrate surface. In the wet cleaning carried out for this purpose, physical cleaning such as scrub cleaning, ultrasonic cleaning and jet cleaning (cleaning with high-pressure water), or chemical cleaning using an acidic or alkaline cleaning solution is employed. Among these, a chemical cleaning of removing an abrasive remaining on the TiO₂—SiO₂ glass substrate surface or a foreign material attached to the surface by a lift-off method is preferred, because the removal efficiency of the abrasive remaining on the TiO₂—SiO₂ glass substrate surface is high. Here, the lift-off method is a method where the TiO₂—SiO₂ glass substrate surface is wet-etched a very small amount with an acid or an alkali to remove an abrasive remaining on the TiO₂—SiO₂ glass substrate surface, a foreign material attached to the surface or the like.

As apparent from the above, the finishing of the TiO₂—SiO₂ glass substrate surface after pre-polishing is usually performed the following procedures:

(a) processing by means of a local processing tool,

(b) chemical-mechanical polishing using a polishing slurry and a polishing pad, and

(c) chemical cleaning using an acidic or alkaline cleaning solution.

Patent Document 1: JP-A-2000-321753

Patent Document 2: Japanese Patent No. 5090633

Patent Document 3: Japanese Patent No. 5367204

Patent Document 4: Japanese Patent No 4506689

Patent Document 5: Japanese Patent No 5169163

### SUMMARY OF THE INVENTION

It is revealed that when the procedures (a) to (c) above are carried out as the finishing of the TiO₂—SiO₂ glass substrate surface after pre-polishing, the surface roughness of the TiO₂—SiO₂ glass substrate surface may deteriorate and the striae-originated MSFR of the TiO₂—SiO₂ glass substrate surface may not satisfy the value required in the use as an EUVL optical base material. Here, the required value of the striae-originated MSFR in an EUVL optical base material is 10 nm or less.

In order to solve those problems of conventional techniques, an object of the present invention is to provide a method of finishing a TiO₂—SiO₂ glass substrate surface, where deterioration of the surface roughness is suppressed.

Another object of the present invention is to provide a TiO₂—SiO₂ glass substrate having an extremely small striae-originated MSFR.

As a result of intensive studies to attain the above-described objects, the present inventors have found that the surface roughness of the TiO₂—SiO₂ glass substrate surface deteriorates due to a chemical etching action in the procedures (b) and (c).

As described above, the finding of the present inventors is as follows.

The TiO₂—SiO₂ glass substrate surface has a variation in the TiO₂/SiO₂ composition ratio, which appears as striped striae. The effect of the chemical etching action in the procedures (b) and (c) differs depending on sites differing in the TiO₂/SiO₂ composition ratio. As a result, the MSFR of the TiO₂—SiO₂ glass substrate surface deteriorates.

The present invention has been made based on the above-described finding. The present invention provides a method of finishing a pre-polished TiO₂—SiO₂ glass substrate, containing:

an MSFR measuring step of measuring a striae-originated MSFR (MSFR₀) of a major surface of the pre-polished TiO₂—SiO₂ glass substrate,

a TiO₂ concentration distribution measuring step of measuring a TiO₂ concentration distribution (ΔTiO₂) in the major surface of the pre-polished TiO₂—SiO₂ glass substrate,

a first processing step of processing the major surface of the pre-polished TiO₂—SiO₂ glass substrate by using a local processing tool with a unit processing area being smaller than the area of the major surface of the pre-polished TiO₂—SiO₂ glass substrate, a second processing step of processing the major surface of the TiO₂—SiO₂ glass substrate after the implementation of the first processing step, by a chemical-mechanical polishing using a polishing pad and a polishing slurry containing an abrasive and an acidic or alkaline dispersion medium, and

a cleaning step of cleaning the major surface of the TiO₂—SiO₂ glass substrate after the implementation of the second processing step, by using an acidic or alkaline cleaning solution, in which

according to the MSFR₀ (nm) determined in the MSFR measuring step and the ΔTiO₂ (wt %) determined in the TiO₂ concentration distribution measuring step, the total etching amount (nm) of a chemical etching amount of the major surface of the TiO₂—SiO₂ glass substrate by the acidic or alkaline dispersion medium used in the second processing step and another chemical etching amount of the major surface of the TiO₂—SiO₂ glass substrate by the acidic or alkaline cleaning solution used in the cleaning step is controlled to satisfy the following expression (1):

Total etching amount≦(10 nm−MSFR₀)v/A/ΔTiO₂ (1)

(in expression (1), v is an average etching rate (nm/sec) of the TiO₂—SiO₂ glass substrate, and A is a TiO₂ concentration dependency (nm/sec/wt %) of an etching rate of the TiO₂—SiO₂ glass substrate).

In the method of finishing a pre-polished TiO₂—SiO₂ glass substrate according to the present invention, the polishing slurry used in the second processing step preferably contains a colloidal silica as the abrasive and the acidic dispersion medium. Alternatively, the polishing slurry used in the second processing step may contain a colloidal silica as the abrasive and the alkaline dispersion medium.

In the method of finishing a pre-polished TiO₂—SiO₂ glass substrate according to the present invention, the cleaning solution used in the cleaning step preferably contain any one alkaline cleaning solution selected from the group consisting of ammonia, sodium hydroxide, potassium hydroxide, an alkaline detergent, and tetramethylammonium hydroxide.

In the method of finishing a pre-polished TiO₂—SiO₂ glass substrate according to the present invention, the cleaning solution used in the cleaning step preferably contain any one acidic cleaning solution selected from the group consisting of hydrofluoric acid and silicofluoric acid.

Further, the present invention provides a TiO₂—SiO₂ glass substrate having a TiO₂ concentration of from 3 mass % to 14 mass %, a TiO₂ concentration distribution (ΔTiO₂) in a major surface of the TiO₂—SiO₂ glass substrate of 0.21 mass % or less, and a striae-originated MSFR of the major surface of the TiO₂—SiO₂ glass substrate of 10 nm or less.

Further, the present invention provides a method of measuring a TiO₂ concentration distribution in a major surface of a TiO₂—SiO₂ glass substrate, containing:

measuring a striae-originated MSFR (MSFR₀) of the major surface of the TiO₂—SiO₂ glass substrate,

etching the major surface by 2 nm or more in terms of an etching amount, measuring another striae-originated MSFR (MSFR₁) in the major surface after the etching, and

determining the TiO₂ concentration distribution (ΔTiO₂) in the major surface of the TiO₂—SiO₂ glass substrate from an MSFR increment (ΔMSFR (MSFR₁−MSFR₀)) caused by the etching.

Further, the present invention provides a TiO₂—SiO₂ glass substrate having a TiO₂ concentration of from 3 mass % to 14 mass % and a TiO₂ concentration distribution (ΔTiO₂) in a major surface of the TiO₂—SiO₂ glass substrate measured by the method of the present invention of 0.21 mass % or less.

According to the finishing method of the present invention, deterioration of the surface roughness at the time of carrying out the finishing can be suppressed.

The TiO₂—SiO₂ glass substrate of the present invention is suitably used as an EUVL optical base material, because the striae-originated MSFR of a major surface of the TiO₂—SiO₂ glass substrate surface is 10 nm or less.

### BRIEF DESCRIPTION OF THE DRAWINGS

FIG. 1 is a graph showing the relationship between etching amount (nm) and striae-originated MSFR of a major surface of a TiO₂—SiO₂ glass substrate, with respect to before and after etching the major surface of the TiO₂—SiO₂ glass substrate having a ΔTiO₂ of 0.1 mass % with an aqueous 5% hydrofluoric acid solution.

FIG. 2 is a graph showing relationships between ΔTiO₂ and maximum etching amount (nm) allowable within the condition where the striae-originated MSFR of a major surface is not more than 10 nm, when etching of a major surface of a TiO₂—SiO₂ glass substrate with an aqueous 5% hydrofluoric acid solution is performed on TiO₂—SiO₂ glass substrates differing in the 10 nm−MSFR₀.

### MODE FOR CARRYING OUT THE INVENTION

The present invention is described below.

The finishing method of the present invention is a method of finishing a TiO₂—SiO₂ glass substrate. Here, the TiO₂—SiO₂ glass substrate has a TiO₂ concentration of preferably from 3 mass % to 12 mass %, because in the case of using the TiO₂—SiO₂ glass substrate as an EUVL base material, the thermal expansion coefficient thereof in the use temperature region becomes substantially zero.

In the step of polishing a TiO₂—SiO₂ glass substrate used as an EUVL base material, the major surface of the TiO₂—SiO₂ glass substrate is generally subjected to a multiple times of pre-polishing and then subjected to finish-polishing. In the pre-polishing, the TiO₂—SiO₂ glass substrate is roughly polished to a predetermined thickness, followed by end face polishing and chamfering, and both major surfaces thereof are further pre-polished to make the surface roughness and flatness be not more than certain levels. This pre-polishing is carried out a plurality of times, for example, twice or three times. A known method can be used for the pre-polishing. For example, a plurality of double-side lapping/polishing machines are continuously provided, and the TiO₂—SiO₂ glass substrate is sequentially polished by the lapping/polishing machines while changing the abrasive or polishing conditions, whereby the major surface of the TiO₂—SiO₂ glass substrate is pre-polished to predetermined surface roughness and flatness.

Also in the finishing method of the present invention, a TiO₂—SiO₂ glass substrate with the major surface being pre-polished is finished. Here, the major surface of the TiO₂—SiO₂ glass substrate is preferably pre-polished to have a flatness (PV value) of 1 μm or less, more preferably 500 nm or less.

The finishing method of the present invention contains the following steps.

### (MSFR Measuring Step)

In this step, the striae-originated MSFR (MSFR₀) (nm) of the major surface of the pre-polished TiO₂—SiO₂ glass substrate is measured. In this step, the striae-originated MSFR (MSFR₀) of the major surface of the pre-polished TiO₂—SiO₂ glass substrate can be determined by the following procedures 1 to 3.

Procedure 1: The surface profile of the major surface of the pre-polished TiO₂—SiO₂ glass substrate is measured with a 2.5-fold objective lens by using a scanning white interferometer (e.g., NewView of Zygo Corporation).

Procedure 2: A low-pass filter capable of filtering the data corresponding to a spatial wavelength of 50 μm or less from the surface profile data obtained in the procedure 1 is applied so as to remove the surface roughness components irrelevant to striae in the major surface of the TiO₂—SiO₂ glass substrate.

Procedure 3: The difference between the maximum value and minimum value of the surface profile processed in the procedure 2 is obtained as the striae-originated MSFR (MSFR₀) of the major surface of the TiO₂—SiO₂ glass substrate.

### (TiO₂ Concentration Distribution Measuring Step)

In this step, the TiO₂ concentration distribution (ΔTiO₂) in the major surface of the pre-polished TiO₂—SiO₂ glass substrate is measured. In the present invention, the TiO₂ concentration distribution (ΔTiO₂) in the major surface of the TiO₂—SiO₂ glass substrate indicates the difference between the maximum value and minimum value of the TiO₂ concentration in (each site of) the major surface of the TiO₂—SiO₂ glass substrate.

In this step, the method for measuring the TiO₂ concentration distribution (ΔTiO₂) is not particularly limited but includes various methods such as the following (a) to (c):

(a) a method of directly measuring the TiO₂ concentration distribution by measuring the major surface of the TiO₂—SiO₂ glass substrate with an electron beam microanalyzer (EPMA);

(b) a method of measuring the refractive index distribution of the TiO₂—SiO₂ glass substrate with a Fizeau interferometer or the like, and indirectly measuring the TiO₂ concentration distribution from the TiO₂ concentration dependency of the refractive index; and

(c) a method of etching the major surface of the TiO₂—SiO₂ glass substrate by 2 nm or more in terms of etching amount, measuring the striae-originated MSFR (MSFR₁) of the major surface of the TiO₂—SiO₂ glass substrate after the etching, and dividing an MSFR increment (ΔMSFR=MSFR₁−MSFR₀) resulting from etching, which is determined as a difference between the striae-originated MSFR (MSFR₁) of the major surface of the TiO₂—SiO₂ glass substrate after the etching and the striae-originated MSFR (MSFR₀) of the major surface of the pre-polished TiO₂—SiO₂ glass substrate obtained in the MSFR measuring step above, by the TiO₂ concentration dependency of the etching rate of the TiO₂—SiO₂ glass to determine the TiO₂ concentration distribution (ΔTiO₂) in the major surface of the TiO₂—SiO₂ glass substrate.

Among these methods, the method of (c) is preferred, because an average of the TiO₂ concentration distribution in the vicinity of the major surface of the TiO₂—SiO₂ glass substrate, ranging from the major surface of the TiO₂—SiO₂ glass substrate to a depth etched, can be obtained. Here, the striae-originated MSFR (MSFR₁) of the major surface of the TiO₂—SiO₂ glass substrate after the etching can be measured according to the procedures described in the MSFR measuring step above.

In this step, the TiO₂ concentration distribution (ΔTiO₂) in the major surface of the TiO₂—SiO₂ glass substrate is measured, because the TiO₂ concentration distribution (ΔTiO₂) in the major surface of the TiO₂—SiO₂ glass substrate is required to control the total etching amount in the later-described second processing step and cleaning step to a predetermined value or less.

In the case of finishing a plurality of TiO₂—SiO₂ glass substrates cut out from the same TiO₂—SiO₂ glass ingot or a plurality of TiO₂—SiO₂ glass substrates cut out from TiO₂—SiO₂ glass ingots produced under substantially the same conditions, it is not necessary to measure ΔTiO₂ in all TiO₂—SiO₂ glass substrates subjected to finishing, and it is also possible to utilize the measurement results of some TiO₂—SiO₂ glass substrates and omit the measurements of the remaining TiO₂—SiO₂ glass substrates.

In this step, for etching the major surface of the TiO₂—SiO₂ glass substrate, use can be made of, for example, an acidic etching solution such as an aqueous hydrofluoric acid solution and an aqueous silicofluoric acid solution, or an alkaline etching solution such as aqueous ammonia, an aqueous sodium hydroxide solution, an aqueous potassium hydroxide solution, an aqueous tetramethylammonium hydroxide solution, and an alkaline detergent.

In this step, the TiO₂ concentration distribution (ΔTiO₂) in the major surface of the TiO₂—SiO₂ glass substrate can be obtained by dividing an MSFR increment (ΔMSFR) resulting from etching, which is determined according to the procedures above, by the TiO₂ concentration dependency of the etching rate of the TiO₂—SiO₂ glass substrate. Here, the TiO₂ concentration dependency of the etching rate of the TiO₂—SiO₂ glass substrate can be obtained by preparing a plurality of TiO₂—SiO₂ glass samples differing in the TiO₂ concentration, etching these samples under the same conditions, and determining the etching rate of each TiO₂—SiO₂ glass sample.

The TiO₂—SiO₂ glass substrate preferably has a TiO₂ concentration distribution (ΔTiO₂) in the major surface thereof determined in this step being 0.2 mass % or less. This is because the TiO₂—SiO₂ glass substrate having such a TiO₂ concentration distribution is suitable for finishing the major surface thereof to have a striae-originated MSFR of 10 nm or less. The TiO₂ concentration distribution (ΔTiO₂) in the major surface is more preferably 0.15 mass % or less, and still more preferably 0.1 mass % or less.

### (First Processing Step)

In this step, the major surface of the TiO₂—SiO₂ glass substrate is processed by using a local processing tool with a unit processing area being smaller than the area of the major surface of the TiO₂—SiO₂ glass substrate.

On the major surface of the pre-polished TiO₂—SiO₂ glass substrate, there is undulation due to a variation in the TiO₂/SiO₂ composition ratio, specifically, undulation having the same pitch as the pitch of the striped striae due to a variation in the TiO₂/SiO₂ composition ratio. By using a local processing tool with a unit processing area being smaller than the area of the major surface of the TiO₂—SiO₂ glass substrate, and setting the processing conditions of the major surface of the TiO₂—SiO₂ glass substrate for each site of the TiO₂—SiO₂ glass substrate, undulation can be removed from the TiO₂—SiO₂ glass substrate surface and the flatness can be improved.

The local processing tool used for the above-described purpose includes a tool employing, as the processing method, an ion beam etching method, a gas cluster ion beam (GCIB) etching method, a plasma etching method, a wet etching method, or a magnetic fluid (MRF (registered trademark)) polishing method, and a rotary small processing tool.

Since the local processing tool has a unit processing area smaller than the area of the major surface of the TiO₂—SiO₂ glass substrate, the local processing tool is made to scan on the major surface of the TiO₂—SiO₂ glass substrate so as to process the entire major surface of the TiO₂—SiO₂ glass substrate.

Incidentally, in the case of a TiO₂—SiO₂ glass substrate used as an EUVL base material, it is the quality guarantee region including a region on which a mask pattern is formed out of the TiO₂—SiO₂ glass substrate surface that is required to have a surface excellent in the flatness and smoothness. For example, the TiO₂—SiO₂ glass substrate used as an EUVL base material is usually a glass substrate having a 152 mm-square substrate surface, and a typical example of the quality guarantee region is a 142 mm square out of the surface above. In this case, the local processing tool used in the first processing step preferably has a unit processing area smaller than the area of the quality guarantee region of the TiO₂—SiO₂ glass substrate.

The local processing tool used in this step includes, in terms of the processing method, an ion beam etching method, a gas cluster ion beam (GCIB) etching method, a plasma etching method, a wet etching method, and a magnetic fluid polishing method. In addition, a rotary small processing tool can be used as the local processing tool. In this step, at least one of the local processing tools described above can be used.

The ion beam etching, gas cluster ion beam etching and plasma etching are methods involving beam irradiation of the major surface of the TiO₂—SiO₂ glass substrate, and the major surface of the TiO₂—SiO₂ glass substrate is scanned with the beam while adjusting the beam irradiation conditions depending on the surface profile of the major surface of the TiO₂—SiO₂ glass substrate. The beam scanning method includes luster scanning, spiral scanning or the like and any of these scanning methods may be used.

Among the above-described methods involving beam irradiation of the major surface of the TiO₂—SiO₂ glass substrate, gas cluster ion beam etching is preferably used, because the major surface can be processed into a surface having small surface roughness and excellent flatness.

The gas cluster ion beam etching is a method in which a reactive substance (source gas) being gaseous at normal temperature and atmospheric pressure is jetted in a pressurized state into a vacuum apparatus through an expansion-type nozzle, thereby forming a gas cluster, the gas cluster is electron-irradiated to form ionized gas cluster ion beam, and a target is irradiated and etched with the ionized gas cluster ion beam. The gas cluster is composed of a massive atomic group or molecular group usually consisting of several thousand atoms or molecules. In the case of using gas cluster ion beam etching in the first processing step of the present invention, at the time of collision of the gas cluster with the major surface of the TiO₂—SiO₂ glass substrate, a multiple collision effect is generated due to an interaction with a solid, and the major surface of the TiO₂—SiO₂ glass substrate is thereby processed.

In the case of using gas cluster ion beam etching, as the source gas, use can be made of gases such as SF₆, Ar, O₂, N₂, NF₃, N₂O, CHF₃, CF₄, C₂F₆, C₃F₈, C₄F₆, SiF₄ and COF₂ each individually or as a mixture. Among these, SF₆ and NF₃ are excellent as the source gas in terms of chemical reaction occurring at the time of collision with the surface of the glass substrate. Therefore, preferred are mixed gases containing SF₆ or NF₃, specifically, a mixed gas of SF₆ and O₂, a mixed gas of SF₆, Ar and O₂, a mixed gas of NF₃ and O₂, a mixed gas of NF₃, Ar and O₂, a mixed gas of NF₃ and N₂, and a mixed gas of NF₃, Ar and N₂. In these mixed gases, the suitable mixing ratio of respective components differs depending on the conditions such as irradiation conditions, but the following ratios are preferred:
SF₆:O₂=from 0.1% to 5%:from 95% to 99.9% (a mixed gas of SF₆ and O₂),
SF₆:Ar:O₂=from 0.1% to 5% :from 9.9% to 49.9% :from 50% to 90% (a mixed gas of SF₆, Ar and O₂),
NF₃:O₂=from 0.1% to 5%:from 95% to 99.9% (a mixed gas of NF₃ and O₂),
NF₃:Ar:O₂=from 0.1% to 5%:from 9.9% to 49.9%:from 50% to 90% (a mixed gas of NF₃, Ar and O₂),
NF₃:N₂=from 0.1% to 5%:from 95% to 99.9% (a mixed gas of NF₃ and N₂), and
NF₃:Ar:N₂=from 0.1% to 5%:from 9.9% to 49.9%:from 50% to 90% (a mixed gas of NF₃, Ar and N₂).

Among these mixed gases, the mixed gas of NF₃ and N₂, the mixed gas of SF₆ and O₂, the mixed gas of SF₆, Ar and O₂, the mixed gas of NF₃ and O₂, and the mixed gas of NF₃, Ar and O₂ are preferred.

Incidentally, the irradiation conditions including a cluster size, an ionizing current applied to an ionizing electrode of a gas cluster ion beam etching device for ionizing gas clusters, an accelerating voltage applied to an accelerating electrode of the gas cluster ion beam etching device, and a dose amount of gas cluster ion beams, can be appropriately selected according to the type of the source gas or the surface profile of the major surface of the pre-polished TiO₂—SiO₂ glass substrate. For example, in order to improve the flatness by removing undulation from the major surface of the TiO₂—SiO₂ glass substrate without excessively deteriorating the surface roughness of the major surface of the TiO₂—SiO₂ glass substrate, the accelerating voltage applied to the accelerating electrode is preferably from 15 to 30 kV.

The magnetic fluid (MRF (registered trademark)) polishing method is a method of polishing the to-be-polished site of a target by using a magnetic fluid containing abrasive particles. The magnetic fluid polishing method is described, for example, in JPA-2010-82746 and Japanese Patent No. 4,761,901. The polishing device employing the MRF (registered trademark) polishing method and the polishing procedure in the polishing device are exemplified in JP-A-2010-82746.

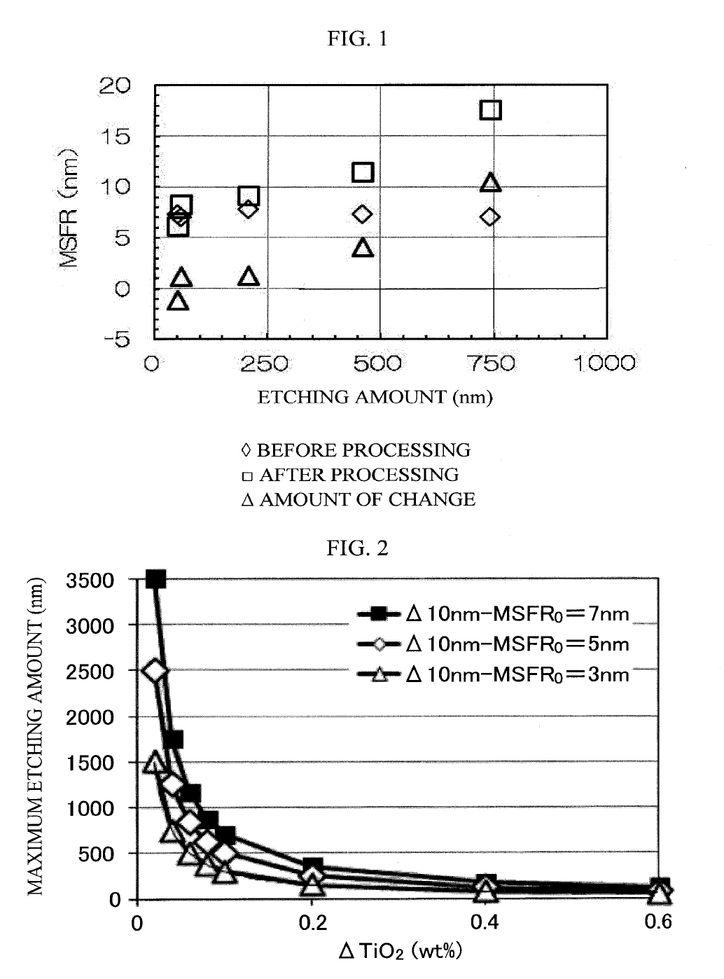

In the MRF (registered trademark) polishing method, a to-be-polished site is pushed by a magnetic fluid, and the magnetic fluid in contact with the to-be-polished site grinds off a convex part of the to-be-polished site, whereby polishing is performed. Therefore, in the case of the polishing device 10 shown in FIG. 1 of JP-A-2010-82746, at least the first polishing is preferably performed in the state of the to-be-polished site 51 being pushed to a depth of 20% or more, more preferably 30% or more, of the maximum height of the magnetic fluid 30 put on a circumferential surface 111. The polishing is preferably performed in the state of the to-be-polished site 51 being pushed to a depth of 50% or less of the maximum height of the magnetic fluid 30 put on the circumferential surface 111.

The magnetic fluid in the MRF (registered trademark) polishing method is a fluid where a non-colloidal magnetic substance is dispersed in a carrier, and when placed under a magnetic field, its rheology properties (viscosity, elasticity and plasticity) become changed. The specific composition is appropriately set according to conventional techniques.

The magnetic fluid preferably has a viscosity coefficient of 30.0×10⁻³ Pa·s or more, more preferably 35.0×10⁻³ Pa·s or more, and most preferably 40.0×10⁻³ Pa·s or more. The viscosity coefficient as used herein indicates a viscosity coefficient at room temperature (about 15° C. to 25° C.) when the magnetic fluid is placed in a non-magnetic field (an atmosphere where a magnetic field is not actively generated). When the viscosity coefficient is within the range above, the maximum height of the magnetic fluid put on a circumferential surface of a wheel is usually from 1.0 mm to 2.0 mm.

On the other hand, the magnetic fluid preferably has a viscosity coefficient of 70.0×10⁻³ Pa·s or less, and more preferably 65.0×10⁻³ Pa·s or less.

As described above, the magnetic fluid used in the MRF (registered trademark) polishing method contains abrasive particles. From the standpoint that the surface roughness of the to-be-polished surface is easily made a desired value or less, the abrasive particle preferably has an average particle diameter of 30 μm or less, more preferably 20 μm or less, and most preferably 15 μm or less.

On the other hand, if the average particle diameter of the abrasive particle is too small, the polishing efficiency is likely to deteriorate. Therefore, the average particle diameter of the abrasive particle is preferably 0.5 μm or more, more preferably 3.0 μm or more, and most preferably 5.0 μm or more.

The abrasive particle may be composed of at least one member of known materials such as silica, cerium oxide and diamond, but from the standpoint that the polishing efficiency can be enhanced, the abrasive particle is preferably composed of at least one member selected from the group consisting of cerium oxide and diamond. Specifically, use can be made of diamond paste (D-20, D-10, etc., produced by QED Technologies) and cerium oxide (C-20, C-10, etc., produced by QED Technologies). The abrasive particle is more preferably composed of cerium oxide, because the surface roughness is easily made a desired value or less.

The processing method by a rotary small processing tool is a method of bringing a polishing part of the tool rotated by a motor into contact with a to-be-processed site and polishing the to-be-processed site.

The rotary small processing tool may be any tool as long as the polishing part thereof is a rotating body capable of effecting the polishing. The system of the rotary small processing tool includes, for example, a system where a small plate is pressed against a target substrate by vertically applying a pressure from right above the substrate and rotated by a shaft perpendicular to the substrate surface, and a system where a rotary processing tool attached to a small polishing plate is pressed against the substrate surface by applying a pressure from an oblique direction.

In the processing by a rotary small processing tool, the area contacting the to-be-processed site is important, and the contact area is preferably from 1 mm² to 500 mm², and more preferably from 50 mm² to 300 mm².

In the processing by a rotary small processing tool, the rotation rate of the polishing part is also important. The rotation rate of the polishing part is preferably from 50 rpm to 2,000 rpm, more preferably from 100 rpm to 1,800 rpm, and still more preferably from 200 rpm to 1,600 rpm.

In the processing by a rotary small processing tool, the pressure at the time of contacting the to-be-processed site is also important, and the pressure is preferably from 1 g-weight/mm² to 30 g-weight/mm², and more preferably from 2 g-weight/mm² to 16 g-weight/mm².

In the processing by a rotary small processing tool, the processing is preferably performed with the intervention of a polishing abrasive grain slurry. The polishing abrasive grain includes silica, cerium oxide, Alundum, White Alundum (WA), FO, zirconia, SiC, diamond, titania, germania, and the like. The polishing abrasive grain can be appropriately selected depending on the specification of the TiO₂—SiO₂ glass substrate as a processing target. Of these abrasive grains, silica is excellent in ease of making the surface roughness a desired value or less but is low in the polishing rate, and Alundum, zirconia, diamond, or the like has a high polishing rate but are sometimes liable to cause surface roughening. For these reasons, among those, cerium oxide is preferred in that the surface roughness is easily made a desired value or less while keeping a high polishing rate.

The local processing tool used in the first processing step is sufficient as long as it has a unit processing area smaller than the area of the major surface of the TiO₂—SiO₂ glass substrate. If the unit processing area of the local processing tool is too large, the ability to correct a local uneven profile existing in the major surface of the TiO₂—SiO₂ glass substrate decreases. Therefore, the unit processing area of the local processing tool is preferably 500 mm² or less, and more preferably 300 mm² or less.

On the other hand, if the unit processing area of the local processing tool is excessively reduced, too much time may be required for processing of the entire major surface of the TiO₂—SiO₂ glass substrate, causing a problem. The minimum value of the unit processing area of the local processing tool is set from the processing rate of the local processing tool and the processing time of the entire major surface of the TiO₂—SiO₂ glass substrate but, for example, is preferably 1 mm² or more, and more preferably 50 mm² or more.

### (Second Processing Step)

In this step, the major surface of the TiO₂—SiO₂ glass substrate after the implementation of the first processing step is processed by chemical-mechanical polishing using a polishing slurry containing an abrasive and an acidic or alkaline dispersion medium and a polishing pad.

In the first processing step, the major surface of the TiO₂—SiO₂ glass substrate is processed by using a local processing tool with a unit processing area being smaller than the area of the major surface of the TiO₂—SiO₂ glass substrate. Therefore, the TiO₂—SiO₂ glass substrate after the implementation of the first processing step is sometimes subject to deterioration of the surface roughness of the major surface. In the second processing step, the major surface of the TiO₂—SiO₂ glass substrate is chemical-mechanical polished by using a polishing slurry and a polishing pad, whereby the surface roughness of the major surface of the TiO₂—SiO₂ glass substrate is improved.

The abrasive in the polishing slurry is preferably colloidal silica or cerium oxide. Use of colloidal silica is more preferred, because the major surface of the TiO₂—SiO₂ glass substrate can be more precisely processed.

In the case of using colloidal silica as the abrasive, the colloidal silica preferably has an average particle diameter of from 1 nm to 100 nm, and more preferably from 10 nm to 50 nm. When the average particle diameter of the colloidal silica is 1 nm or more, the processing efficiency of the major surface of the TiO₂—SiO₂ glass substrate can be enhanced. On the other hand, when the average particle diameter of the colloidal silica is 100 nm or less, the surface roughness of the major surface of the TiO₂—SiO₂ glass substrate after the implementation of the second processing step can be reduced.

In the case of using cerium oxide as the abrasive, the cerium oxide preferably has an average particle diameter of from 10 nm to 5,000 nm, more preferably from 100 nm to 3,000 nm, and still more preferably from 500 nm to 2,000 nm. Incidentally, the average particle diameter of the abrasive in the present invention indicates a D50 value measured by a particle diameter analyzer employing a laser diffraction/scattering method or a dynamic light scattering method (e.g., Microtrac or Nanotrac, manufactured by Nikkiso Co., Ltd.).

The content of the colloidal silica in the polishing slurry is preferably from 1 mass % to 40 mass %, and more preferably from 10 mass % to 30 mass %. When the content of the colloidal silica in the polishing slurry is 1 mass % or more, the processing efficiency of the major surface of the TiO₂—SiO₂ glass substrate can be enhanced. On the other hand, when the content of the colloidal silica in the polishing slurry is 40 mass % or less, the cleaning efficiency in the cleaning step that is subsequently carried out can be enhanced. The content of the cerium oxide in the polishing slurry is preferably from 1 mass % to 50 mass %, more preferably from 5 mass % to 40 mass %, and still more preferably from 10 mass % to 30 mass %.

In order to adjust the pH of the polishing slurry to a desired value, an acid or an alkali dispersion medium is usually used as the dispersion medium for the abrasive. As for the acidic dispersion medium, hydrochloric acid, nitric acid or acetic acid is usually used. As for the alkaline dispersion medium, sodium hydroxide, potassium hydroxide, ammonia, or tetramethylammonium hydroxide is usually used.

The polishing pad includes, for example, a polishing pad having a polyurethane resin foam layer which is obtained by impregnating a base cloth such as nonwoven fabric with a polyurethane resin and subjecting the cloth to a wet coagulation treatment. The polishing pad is preferably a suede-type polishing pad.

The suede-type polishing pad preferably has a nap layer with a thickness of the order of 0.3 mm to 1.0 mm from a practical standpoint. As for the suede-type polishing pad, a soft resin foam having an appropriate compression modulus can be preferably used, and specific examples thereof include ether-based, ester-based and carbonate-based resin foams.

In the case of using the above-described polishing pad, the TiO₂—SiO₂ glass substrate is set by pressing its major surface against a polishing plate attached with the polishing pad such as nonwoven fabric or polishing fabric, and the polishing plate is rotated relative to the TiO₂—SiO₂ glass substrate while supplying a slurry adjusted to predetermined properties, whereby the major surface of the TiO₂—SiO₂ glass substrate is chemical-mechanical polished. Here, both surfaces of the TiO₂—SiO₂ glass substrate, i.e., the major surface and the opposite surface, may also be chemical-mechanical polished by setting the TiO₂—SiO₂ glass substrate to be interposed between polishing plates each attached with the polishing pad such as nonwoven fabric or polishing fabric and rotating the polishing plates relative to the TiO₂—SiO₂ glass substrate while supplying a slurry adjusted to predetermined properties.

As regards the polishing pad used in the second processing step, the contact area during polishing is preferably larger than the area of the major surface of the TiO₂—SiO₂ glass substrate, because the entire major surface of the TiO₂—SiO₂ glass substrate can be polished at the same time.

In the second processing step, the chemical-mechanical polishing is preferably carried out at a surface pressure of 0.01 g-weight/mm² to 0.6 g-weight/mm² If the surface pressure exceeds 0.6 g-weight/mm², scratch flaws may be generated on the major surface of the TiO₂—SiO₂ glass substrate and in addition, the rotational load of the polishing plate may become large. If the surface pressure is less than 0.01 g-weight/mm², the processing requires a long time and this is not practical. The surface pressure at the time of chemical-mechanical polishing is more preferably from 0.3 g-weight/mm² to 0.6 g-weight/mm².

### (Cleaning Step)

In this step, the major surface of the TiO₂—SiO₂ glass substrate after the implementation of the second processing step is cleaned by using an acidic or alkaline cleaning solution.

On the major surface of the TiO₂—SiO₂ glass substrate after the implementation of the second processing step, an abrasive used in the polishing slurry, a foreign material getting mixed in from other members used for the polishing or from the polishing atmosphere or the like may remain. In this step, the abrasive or the like remaining on the major surface of the TiO₂—SiO₂ glass substrate after the implementation of the second processing step is removed by a lift-off method by cleaning the major surface of the TiO₂—SiO₂ glass substrate, with use of an acidic or alkaline cleaning solution.

In this step, either an acidic cleaning solution or an alkaline cleaning solution can be used. However, in this step, an abrasive remaining on the major surface of the TiO₂—SiO₂ glass substrate or a foreign material attached to the major surface is removed by the lift-off method and therefore, an acidic or alkaline cleaning solution having an etching action on the TiO₂—SiO₂ glass is used. The acidic cleaning solution having an etching action on the TiO₂—SiO₂ glass includes hydrofluoric acid and silicofluoric acid. The alkaline cleaning solution having an etching action on the TiO₂—SiO₂ glass includes aqueous ammonia, sodium hydroxide, potassium hydroxide, an alkaline detergent (an aqueous solution containing an alkaline surfactant), and tetramethylammonium hydroxide.

Among these cleaning solutions, hydrofluoric acid is preferred as the acidic cleaning solution, and aqueous ammonia and an alkaline detergent are preferred as the alkaline cleaning solution, because the etching action thereof on the TiO₂—SiO₂ glass is high and a chemical having a high cleanliness with little foreign materials floating in the cleaning solution is available.

In this step, cleaning having a mechanical action on the major surface of the TiO₂—SiO₂ glass substrate, such as brush cleaning, scrub cleaning, jet cleaning, ultrasonic cleaning, or two-fluid cleaning, may be used in combination. Furthermore, in this step, cleaning using a cleaning solution not having an etching action on the TiO₂—SiO₂ glass, for example, a mixed solution of sulfuric acid and hydrogen peroxide water, may be used in combination.

As described above, in the cleaning step, a cleaning solution having an etching action on the TiO₂—SiO₂ glass is used as the acidic or alkaline cleaning solution. Among the acidic or alkaline dispersion mediums used in the second processing step, there exists a dispersion medium having an etching action on the TiO₂—SiO₂ glass.

Therefore, at the time of implementation of the second processing step and the cleaning step, the major surface of the TiO₂—SiO₂ glass is subject to etching action of the cleaning solution or the dispersion medium.

The present inventors have found that the etching action of the cleaning solution or dispersion medium is one of causes of deteriorating the surface roughness such as MSFR of the major surface of the TiO₂—SiO₂ glass substrate.

In the finishing method of the present invention, according to MSFR_{O} determined in the MSFR measuring step and ΔTiO₂ determined in the TiO₂ concentration distribution measuring step, the total etching amount (nm) of the chemical etching amount of the major surface of the TiO₂—SiO₂ glass substrate by the acidic or alkaline dispersion medium used in the second processing step and the other chemical etching amount of the major surface of the TiO₂—SiO₂ glass substrate by the acidic or alkaline cleaning solution used in the cleaning step is controlled to satisfy the following expression (1), whereby the surface roughness of the major surface of the TiO₂—SiO₂ glass substrate is prevented from deterioration and the striae-originated MSFR of the major surface of the TiO₂—SiO₂ glass substrate is made 10 nm or less.

Total etching amount≦(10 nm−MSFR₀)v/A/ΔTiO₂ (1)

In expression (1), v is the average etching rate (nm/sec) of the TiO₂—SiO₂ glass substrate, and A is the TiO₂ concentration dependency (nm/sec/wt %) of the etching rate of the TiO₂—SiO₂ glass substrate. The A can be determined by etching TiO₂—SiO₂ glass substrates having different TiO₂ concentrations and dividing the change of weight between before and after the etching by the surface area, though the value may vary depending on the composition of the etching solution, the temperature of the etching solution or the etching conditions such as stirring or no stirring of the etching solution. Some examples are recited below.

In the case of hydrofluoric acid that is generally used as a cleaning solution after polishing, assuming that the glass substrate is immersed in hydrofluoric acid at 25° C. with no stirring, A=4.3×10⁻²×exp (0.082×hydrofluoric acid concentration (wt %)) is established.

In the case of sodium hydroxide that is generally used as a dispersion medium of a polishing slurry, assuming that the glass substrate is immersed in an aqueous sodium hydroxide solution at 20° C. with no stirring, A=1.4×10⁻⁵×exp (0.14×sodium hydroxide concentration (wt %)) is established.

In the case of potassium hydroxide that is generally used as a dispersion medium of a polishing slurry, assuming that the glass substrate is immersed in an aqueous potassium hydroxide solution at 20° C. with no stirring, A=5.58×10⁻⁵×exp (0.47×potassium hydroxide concentration (wt %)) is established.

As with A, v may also vary depending on the composition of the etching solution, the temperature of the etching solution or the etching conditions such as stirring or no stirring of the etching solution. The v can be determined by etching a TiO₂—SiO₂ glass substrate having a desired average TiO₂ concentration and dividing the change of weight between before and after etching by the surface area, For example, in the case where a TiO₂—SiO₂ glass substrate having an average TiO₂ concentration of 6.35 wt % is immersed in hydrofluoric acid with a concentration of 5 wt % at a temperature of 25° C. with no stirring, v is 0.43 nm/sec; in the case where the above-described TiO₂—SiO₂ glass substrate is immersed in an aqueous sodium hydroxide solution with a concentration of 2 wt % at a temperature of 25° C. with no stirring, v is 8.91×10⁻⁵ nm/sec; and in the case where the above-described TiO₂—SiO₂ glass substrate is immersed in an aqueous potassium hydroxide solution with a concentration of 2 wt % at a temperature of 25° C. with no stirring, v is 3.57×10⁻⁴ nm/sec.

FIG. 1 is a graph showing the relationship between the etching amount (nm) and the striae-originated MSFR (MSFR before etching (MSFR₀), MSFR after etching (MSFR₁), and MSFR increment ΔMSFR (MSFR₁−MSFR₀) resulting from the etching) of the major surface of the TiO₂—SiO₂ glass substrate, with respect to before and after etching the major surface of a TiO₂—SiO₂ glass substrate having a TiO₂ concentration distribution of 0.13 mass % with an aqueous 5% hydrofluoric acid solution. Here, the etching amount is measured by the following procedure and adjusted by the immersion time in an aqueous 5% hydrofluoric acid solution.

Etching amount: The mass of the TiO₂—SiO₂ glass substrate is measured before and after etching, and the amount of mass loss of the TiO₂—SiO₂ glass substrate by the etching is determined. This amount of mass loss is divided by the density (2.2 g/cm³) of the TiO₂—SiO₂ glass substrate and the area of the etched major surface, whereby the etching amount is calculated.

As for the striae-originated MSFR of the major surface of the TiO₂—SiO₂ glass substrate, the surface profile of the major surface of the TiO₂—SiO₂ glass substrate is measured with a 2.5-fold objective lens before and after etching by using a white interferometer (NewView of Zygo Corporation). The measurement results are low-pass filtered to extract only the surface profile corresponding to a spatial wavelength of 50 μm or more, and the difference between the maximum value and minimum value of the surface profile after low-pass filtering is defined as the striae-originated MSFR.

In FIG. 1, it is revealed that when the etching amount is 200 nm or less, the striae-originated MSFR (MSFR₁) of the major surface of the TiO₂—SiO₂ glass substrate after etching becomes 10 nm or less.

FIG. 2 is a graph showing relationships between ΔTiO₂, and maximum etching amount (nm) allowable within the condition where the striae-originated MSFR of a major surface, which is represented by the right-hand side of expression (1), is not more than 10 nm, when etching of a major surface of a TiO₂—SiO₂ glass substrate with an aqueous 5% hydrofluoric acid solution is performed on TiO₂—SiO₂ glass substrates differing in the 10 nm−MSFR₀. Here, ΔTiO₂ means a TiO₂ concentration distribution in a major surface of a substrate, which can be obtained by the above-described method for measuring the TiO₂ concentration distribution. The graph of FIG. 2 reveals that the maximum etching amount is larger with increasing the 10 nm−MSFR₀ value and with decreasing the ΔTiO₂ value. In particular, the ΔTiO₂ makes a large contribution. The graph of FIG. 2 reveals that in the case where the ΔTiO₂ exceeds 0.4, the maximum etching amount is small regardless of the 10 nm−MSFR₀ value. On the other hand, in the case where the ΔTiO₂ is less than 0.21, the maximum etching amount is large and there is a wide process window of etching.

In the finishing method of the present invention, according to MSFR_{O} determined in the MSFR measuring step and ΔTiO₂ determined in the TiO₂ concentration distribution measuring step, the total etching amount of the chemical etching amount of the major surface of the TiO₂—SiO₂ glass substrate by the acidic or alkaline dispersion medium used in the second processing step and the chemical etching amount of the major surface of the TiO₂—SiO₂ glass substrate by the acidic or alkaline cleaning solution used in the cleaning step is controlled to satisfy expression (1), and this can be achieved by carrying out the following procedure according to the pH of the dispersion medium in the second processing step.

In the case of using an acidic dispersion medium such as nitric acid, hydrochloric acid, citric acid, or formic acid in the second processing step, the chemical etching does not proceed in the second processing step to advantageously cause no deterioration of MSFR. The TiO₂—SiO₂ glass substrate and colloidal silica used as an abrasive have the same sign of surface potential and are expected to generate an electrical repulsive force to a certain extent. However, the action of the electrical repulsive force is small as compared with a case of using an alkaline dispersion medium and the colloidal silica used as an abrasive in the second processing step is likely to attach to or remain on the TiO₂—SiO₂ glass substrate surface, leaving a possibility of causing a trouble at the time of utilizing the glass substrate after finishing.

On this account, in the cleaning step following the second processing step, it is essential to remove an abrasive (colloidal silica) remaining on the major surface of the TiO₂—SiO₂ glass substrate by the lift-off method by using, as the acidic or alkaline cleaning solution, a cleaning solution having a high etching action on the TiO₂—SiO₂ glass, or by carrying out the cleaning step under the conditions conducive to a high etching action on the TiO₂—SiO₂ glass (e.g., using a cleaning solution at a higher concentration, using a cleaning solution at a higher temperature, or carrying out the cleaning for a longer time). Taking into account this viewpoint, the processing conditions in the cleaning step, including the concentration and temperature of the cleaning solution or the cleaning time, are appropriately adjusted, whereby the total etching amount is controlled to satisfy expression (1).

On the other hand, in the case of using an alkaline dispersion medium such as potassium hydroxide in the second processing step, the TiO₂—SiO₂ glass substrate and the colloidal silica used as an abrasive have the same sign of surface potential and moreover, have a large surface charge amount. Therefore, the TiO₂—SiO₂ glass substrate and the colloidal silica used as an abrasive electrically repel each other, as a result, the colloidal silica used as an abrasive is less likely to attach to or remain on the TiO₂—SiO₂ glass substrate surface.

Therefore, in the cleaning step following the second processing step, a cleaning solution having a lower etching action on the TiO₂—SiO₂ glass may be used as the acidic or alkaline cleaning solution. Alternatively, the cleaning step may be carried out under the conditions conducive to a lower etching action on the TiO₂—SiO₂ glass (e.g., using a cleaning solution at a lower concentration, using a cleaning solution at a lower temperature, or carrying out the cleaning for a shorter time). Taking into account this viewpoint, the processing conditions in the cleaning step, including the concentration and temperature of the cleaning solution or the cleaning time, are appropriately adjusted, whereby the total etching amount is controlled to satisfy expression (1).

The chemical etching amount of the major surface of the TiO₂—SiO₂ glass substrate by the acidic or alkaline dispersion medium used in the second processing step differs depending on the type of the acidic or alkaline dispersion medium used in the second processing step. For example, an inorganic acid such as nitric acid and hydrochloric acid, or an organic acid such as citric acid and acetic acid has almost no etching action on the TiO₂—SiO₂ glass and therefore, the chemical etching amount of the major surface of the TiO₂—SiO₂ glass substrate is substantially 0 nm. In this case, the above-described total etching amount is the chemical etching amount of the major surface of the TiO₂—SiO₂ glass substrate by the acidic or alkaline cleaning solution used in the cleaning step.

On the other hand, sodium hydroxide, potassium hydroxide, aqueous ammonia, and an alkaline detergent have an etching action on the TiO₂—SiO₂ glass. Since the chemical etching amount of the major surface of the TiO₂—SiO₂ glass substrate depends on the concentration of such a dispersion medium or the contact time with the major surface of the TiO₂—SiO₂ glass, the chemical etching amount of the major surface of the TiO₂—SiO₂ glass substrate can be controlled by adjusting the concentration or contact time. In the case of adjusting the contact time with the major surface of the TiO₂—SiO₂ glass substrate in the second processing step, the contact time may be adjusted by controlling the time for which the second processing step is carried out, that is, the time for which the major surface of the TiO₂—SiO₂ glass is chemical-mechanical polished.

On the other hand, as for the acidic or alkaline cleaning solution used in the cleaning step, all cleaning solutions have an etching action on the TiO₂—SiO₂ glass. Since the chemical etching amount of the major surface of the TiO₂—SiO₂ glass substrate depends on the concentration of such a cleaning solution or the contact time with the major surface of the TiO₂—SiO₂ glass, the chemical etching amount of the major surface of the TiO₂—SiO₂ glass substrate can be controlled by adjusting the concentration or contact time. In the case of adjusting the contact time with the major surface of the TiO₂—SiO₂ glass substrate in the cleaning step, the contact time may be adjusted by controlling the time for which the cleaning step is carried out.

In the finishing method of the present invention, after the implementation of the cleaning step, the major surface of the TiO₂—SiO₂ glass substrate is rinsed for the purpose of, for example, removing the cleaning solution. As for the rinsing solution, ultrapure water is usually used. The TiO₂—SiO₂ glass substrate after rinsing is dried to remove the rinsing solution from the major surface of the TiO₂—SiO₂ glass substrate. For this drying, spin drying or VAPOR drying is usually employed.

In the case of employing a plurality of cleanings in combination in the cleaning step, the major surface of the TiO₂—SiO₂ glass substrate is preferably rinsed with ultrapure water between individual cleanings for the purpose of, for example, removing the cleaning solution used in the previous cleaning.

The TiO₂—SiO₂ glass substrate finished by the method of the present invention is suitably used as an EUVL optical base material, a base material of a magnetic recording medium, or a base material of a nanoimprint lithography mold, because the striae-originated MSFR of the major surface is 10 nm or less.

The TiO₂—SiO₂ glass substrate of the present invention has a TiO₂ concentration of from 3 mass % to 14 mass %, a TiO₂ concentration distribution in the major surface of 0.21 mass % or less, and a striae-originated MSFR of the major surface of 10 nm or less.

The TiO₂—SiO₂ glass substrate of the present invention is preferably obtained by the above-described finishing method of the present invention but may be obtained by other methods. For example, the following methods may be used:

Method 1: a method of removing unevenness due to striae in the major surface of the TiO₂—SiO₂ glass substrate by finish polishing using a local polishing tool (e.g., the method described in Japanese Patent No. 4,506,689);

Method 2: a method of mechanically polishing the entire major surface of the TiO₂—SiO₂ glass substrate by appropriately using a polishing slurry and a polishing pad (the method described in JP-A-2014-083597); and

Method 3: a method of reducing the TiO₂ concentration distribution of a glass material (e.g., the method described in Japanese Patent No. 5,365,248).

### EXAMPLES

The present invention is described in detail below by referring to Examples. Examples 1, 3 and 5 to 10 are Examples of the present invention, and Examples 2 and 4 are Comparative Examples. In these Examples, the following procedures were carried out.

### Example 1

An ingot of synthetic quartz glass (TiO₂—SiO₂ glass) containing 7 mass % of TiO₂, produced by a flame hydrolysis method, was cut into a plate shape of 153.0 mm (length)×153.0 mm (width)×6.75 mm (thickness) by using an inner blade slicer to prepare 60 pieces of plate-shaped samples of synthetic quartz glass (TiO₂—SiO₂ glass). This plate-shaped sample is hereinafter referred to as “sample substrate”. Next, these sample substrates were chamfered by using a commercially available NC chamfering machine with a diamond grinding stone of #120 to have longitudinal and lateral external dimensions of 152 mm and a chamfer width of from 0.2 mm to 0.4 mm.

### (Pre-Polishing Step)

The sample substrate was pre-polished by the following method.

First, the major surface of the sample substrate was polished by means of a 20B double-side lapping machine manufactured by Speedfam Co., Ltd. by using, as an abrasive, a slurry in which from 18 mass % to 20 mass % of GC #400 (produced by Fujimi Incorporated) substantially composed of SiC was suspended in filtered water, until the thickness became 6.63 mm.

Furthermore, the sample substrate was polished by means of another 20B double-side lapping machine by using, as an abrasive, a slurry in which from 18 mass % to 20 mass % of FO #1000 (produced by Fujimi Incorporated) composed mainly of Al₂O₃ was suspended, until the thickness became 6.51 mm. Thereafter, the outer periphery of the sample substrate was polished 30 μm by using a slurry mainly composed of cerium oxide and a buff so as to mirror-finish the end face to have a surface roughness (Ra) of 0.05 μm.

Next, as primary polishing, these sample substrates were polished 50 μm in total of both surfaces by means of a 20B double-side polishing machine manufactured by Speedfam Co. by using, as abrasive cloth, LP66 (trade name, produced by Rhodes Co.) and by using, as an abrasive, a slurry in which from 10 mass % to 12 mass % of MIREK 801A (trade name, produced by Mitsui Kinzoku) was suspended.

Furthermore, as secondary polishing, each sample substrate was polished 10 μm in total of both surfaces by means of the 20B double-side polishing machine by using, as abrasive cloth, Seagull 7355 (trade name, produced by Toray Coatex Co., Ltd.) and by using, as an abrasive, the above-described MIREK 801A, followed by simple cleaning.

### (MSFR Measuring Step, TiO₂ Concentration Distribution Measuring Step)

The sample substrates after pre-polishing were measured for the striae-originated MSFR (MSFR₀) of the major surface according to the MSFR measuring step described above. As a result, MSFR₀ was 9.8 nm.

In addition, the sample substrates after pre-polishing were measured for the TiO₂ concentration distribution (ΔTiO₂) in the major surface by the method (c) described above. As a result, ΔTiO₂ was 0.21 wt %.

### (First Processing Step)

The major surface of the sample substrate after pre-polishing was then processed by gas cluster ion beam etching. The gas cluster ion beam etching was performed by using an apparatus, US50XP, manufactured by Epion, and the entire major surface of the sample substrate was processed by raster scanning of gas cluster ion beams.

The processing conditions were:

source gas: a mixed gas of NF₃:O₂=5:95%,

accelerating voltage: 30 kV,

ionizing current: 70 μA, and

beam diameter of gas cluster ion beam (FWHM value): 6 mm.

### (Second Processing Step)

The entire major surface of the sample substrate after the implementation of the first processing step was processed by a chemical-mechanical polishing using a double-side polishing machine (24B, manufactured by Hamai Co., Ltd.).

The processing conditions were:

polishing pad: Bellatrix N7512 manufactured by Filwel, Co., Ltd.,

rotation rate of polishing plate: 10 rpm,

polishing time: 60 minutes,

polishing load: 0.25 g-weight/mm²,

polishing amount: 0.06 μm/surface,

slurry flow rate: 10 liter/min, and

polishing slurry: a slurry containing 20 mass % of colloidal silica having an average primary particle diameter of less than 20 nm, in which the dispersion medium contained nitric acid and the pH was adjusted to 2.0.

Incidentally, in this second processing step, nitric acid not having an etching action on the TiO₂—SiO₂ glass is used as the dispersion medium for the abrasive and therefore, the chemical etching amount of the major surface of the sample substrate is 0.0 nm.

### (Cleaning Step)

The sample substrate after the implementation of the second processing step was subjected to the following procedures.

Procedure 1: The entire major surface of the sample substrate was scrub-cleaned for 60 seconds by using an alkaline surfactant-containing aqueous solution (pH: 12, room temperature) as a cleaning solution.

Procedure 2: The major surface of the sample substrate was rinsed by using ultrapure water (room temperature).

Procedure 3: The major surface of the sample substrate was immersed in an aqueous 0.3% hydrofluoric acid solution (room temperature) for 10 seconds.

Procedure 4: The major surface of the sample substrate was rinsed by using ultrapure water (room temperature).

Procedure 5: The major surface of the sample substrate was ultrasonically cleaned by using an aqueous ammonia solution having a concentration of 0.01 wt % (pH: 10, room temperature).

Procedure 6: The major surface of the sample substrate was rinsed by using ultrapure water (room temperature).

Procedure 7: The sample substrate was spin-dried.

In this cleaning step, cleaning solutions having an etching action on the TiO₂—SiO₂ glass were used in procedures 1, 3 and 5. However, the etching action of the cleaning solutions used in procedures 1 and 5 is minimal as compared with the etching action of the cleaning solution used in procedure 3 and is negligible. Therefore, the etching action of the cleaning solution used in procedure 3 is taken as the etching action in the cleaning step. The chemical etching amount of the major surface of the sample substrate by the cleaning solution used in procedure 3 is 2.8 nm.

As described above, MSFR₀ obtained in the MSFR measuring step is 9.8 nm, and ΔTiO₂ obtained in the TiO₂ concentration distribution measuring step is 0.21 wt %. In addition, A representing the TiO₂ concentration dependency of the etching rate of the sample substrate is 4.3×10⁻²×exp (0.082×0.3)=0.044 nm/sec/wt %, because an aqueous 0.3% hydrofluoric acid solution is used as the cleaning solution in procedure 3. And v representing the average etching rate of the sample substrate is 0.28 nm/sec. These lead to (10 nm−MSFR₀)v/A/ΔTiO₂=5.5 nm. Then, the total chemical etching amount of the major surface of the sample substrate by the second processing step and cleaning step is 0.0 nm+2.8 nm=2.8 nm, which is <5.5 nm, and expression (1) is satisfied. The sample substrate after the implementation of procedure 7 was measured for striae-originated MSFR of the major surface according to the MSFR measuring step described above, as a result, MSFR was 9.9 nm, confirming that the surface roughness is prevented from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 3.

### Example 2

The same procedures as in Example 1 were carried out except that in procedure 3 of the cleaning step, the major surface of the sample substrate was immersed in an aqueous 0.3% hydrofluoric acid solution (room temperature) for 60 seconds. The chemical etching amount of the major surface of the sample substrate by the cleaning solution used in procedure 3 is 16.5 nm.

MSFR₀ obtained in the MSFR measuring step is 9.8 nm, and ΔTiO₂ obtained in the TiO₂ concentration distribution measuring step is 0.21 wt %. In addition, A representing the TiO₂ concentration dependency of the etching rate of the sample substrate is 4.3×10⁻²×exp (0.082×0.3)=0.044 nm/sec/wt %, because an aqueous 0.3% hydrofluoric acid solution is used as the cleaning solution in procedure 3. And v representing the average etching rate of the sample substrate is 0.28 nm/sec.

These lead to (10 nm−MSFR₀)v/A/ΔTiO₂=5.5 nm. Then, the total etching amount of the major surface of the sample substrate by the second processing step and cleaning step is 0.0 nm+16.5 nm=16.5 nm, which is >5.5 nm, and expression (1) is not satisfied.

The sample substrate after the implementation of procedure 7 was measured for striae-originated MSFR of the major surface according to the MSFR measuring step described above, as a result, MSFR was 10.4 nm, failing in preventing the surface roughness from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 4.

### Example 3

The same procedures as in Example 1 were carried out except that in procedure 3 of the cleaning step, the major surface of the sample substrate was immersed in mixed solution of sulfonic acid (concentration: 98%):hydrogen peroxide water (concentration: 30%)=1:1 for 60 seconds.

In this cleaning step, cleaning solutions having an etching action on the TiO₂—SiO₂ glass were used in procedures 1, 3 and 5, but the etching action of all of the cleaning solutions used in procedures 1, 3 and 5 is minimal and less than 0.1 nm.

MSFR₀ obtained in the MSFR measuring step is 9.8 nm, and ΔTiO₂ obtained in the TiO₂ concentration distribution measuring step is 0.21 wt %. In addition, A representing the TiO₂ concentration dependency of the etching rate of the sample substrate was regarded as <0.1 nm/sec/wt %, because the etching action of all of the cleaning solutions used in procedures 1, 3 and 5 is minimal, and v representing the average etching rate of the sample substrate was also regarded as <0.1 nm/sec. These lead to (10 nm−MSFR₀)v/A/ΔTiO₂<0.1 nm. Then, the total chemical etching amount of the major surface of the sample substrate by the second processing step and cleaning step is 0.0 nm+(<0.1 nm)=(<0.1 nm), and expression (1) is satisfied.

The sample substrate after the implementation of procedure 7 was measured for striae-originated MSFR of the major surface according to the MSFR measuring step described above, as a result, MSFR was 9.8 nm, confirming that the surface roughness is prevented from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 7.

### Example 4

The same procedures as in Example 2 were carried out except that in the second processing step, a polishing slurry containing 20 mass % of colloidal silica with an average primary particle diameter of less than 20 nm, in which the dispersion medium contained potassium hydroxide and the pH was adjusted to 11, was used as the polishing slurry.

In this second processing step, the dispersion medium for the abrasive is potassium hydroxide having an etching action on the TiO₂—SiO₂ glass and therefore, the chemical etching amount of the major surface of the sample substrate is 13.2 nm.

MSFR₀ obtained in the MSFR measuring step is 9.8 nm, and ΔTiO₂ obtained in the TiO₂ concentration distribution measuring step is 0.21 wt %. In addition, potassium hydroxide is used as the dispersion medium for the abrasive in the second processing step and an aqueous 0.3% hydrofluoric acid solution is used as the cleaning solution in procedure 3 of the cleaning step, the numerical values of A and v in these steps are as follows:

A in second processing step is 5.8×10⁻⁴ nm/sec/wt %;

v in second processing step is 0.0037 nm/sec;

A in cleaning step is 0.044 nm/sec/wt %; and

v in cleaning step is 0.28 nm/sec.

These lead to (10 nm−MSFR₀)v/A/ΔTiO₂ is 5.5 nm in the second processing step and (10 nm−MSFR₀)v/A/ΔTiO₂ is 5.5 nm in the cleaning step, and in turn, the allowable etching amount is 5.5+5.5=11.0 nm. Then, the total chemical etching amount of the major surface of the sample substrate by the second processing step and cleaning step is 13.2 nm+2.8 nm=16.0 nm, which is >11.0 nm, and expression (1) is not satisfied.

The sample substrate after the implementation of procedure 7 was measured for striae-originated MSFR of the major surface according to the MSFR measuring step described above, as a result, MSFR was 10.4 nm, failing in preventing the surface roughness from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 3.

### Example 5

The same procedures as in Example 2 were carried out except that in the second processing step, a polishing slurry containing 20 mass % of colloidal silica with an average primary particle diameter of less than 20 nm, in which the dispersion medium contained potassium hydroxide and the pH was adjusted to 10, was used as the polishing slurry and the polishing time and polishing amount were changed to 30 minutes and 0.03 μm/surface, respectively.

In this second processing step, the dispersion medium for the abrasive is potassium hydroxide having an etching action on the TiO₂—SiO₂ glass and therefore, the chemical etching amount of the major surface of the sample substrate is 2.6 nm.

MSFR₀ obtained in the MSFR measuring step is 9.8 nm, and ΔTiO₂ obtained in the TiO₂ concentration distribution measuring step is 0.21 wt %. In addition, potassium hydroxide is used as the dispersion medium for the abrasive in the second processing step, and an aqueous 0.3% hydrofluoric acid solution is used as the cleaning solution in procedure 3 of the cleaning step. In the former, A=2.3×10⁻⁴ nm/sec/wt % and v=1.4×10⁻³ nm/sec. In the latter, A=0.044 nm/sec/wt % and v=0.28 nm/sec. From these, the allowable etching amount becomes 5.5+5.5=11.0 nm. Then, the total chemical etching amount of the major surface of the sample substrate by the second processing step and cleaning step is 2.6 nm+2.8 nm=5.4 nm, which is <11.0 nm, and expression (1) is satisfied.

The sample substrate after the implementation of procedure 7 was measured for striae-originated MSFR of the major surface according to the MSFR measuring step described above, as a result, MSFR was 10.0 nm, confirming that the surface roughness is prevented from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 5.

### Example 6

The same procedures as in Example 1 were carried out except that in the second processing step, a polishing slurry containing 20 mass % of colloidal silica with an average primary particle diameter of less than 20 nm, in which the dispersion medium contained only ultrapure water and the pH was 7, was used as the polishing slurry.

MSFR₀ obtained in the MSFR measuring step is 9.8 nm, and ΔTiO₂ obtained in the TiO₂ concentration distribution measuring step is 0.21 wt %. In addition, A representing the TiO₂ concentration dependency of the etching rate of the sample substrate is 4.3×10⁻²×exp (0.082×0.3)=0.044 nm/sec/wt %, because an aqueous 0.3% hydrofluoric acid solution is used as the cleaning solution in procedure 3. And v representing the average etching rate of the sample substrate is 0.28 nm/sec. These lead to (10 nm−MSFR₀)v/A/ΔTiO₂=5.5 nm. Then, the total chemical etching amount of the major surface of the sample substrate by the second processing step and cleaning step is 0.0 nm+2.8 nm=2.8 nm, which is <5.5 nm, and expression (1) is satisfied.

The sample substrate after the implementation of procedure 7 was measured for striae-originated MSFR of the major surface according to the MSFR measuring step described above, as a result, MSFR was 9.9 nm, confirming that the surface roughness is prevented from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 5.

### Example 7

The same procedures as in Example 2 were carried out except that the polishing slurry used in the second processing step was the same as that in Example 5, and that a sample substrate having a striae-originated MSFR (MSFR₀) of the major surface after pre-polishing of 9.3 nm and a TiO₂ concentration distribution (ΔTiO₂) in the major surface of 0.19 wt % was used. Potassium hydroxide is used as the dispersion medium for the abrasive in the second processing step, and an aqueous 0.3% hydrofluoric acid solution is used as the cleaning solution in procedure 3 of the cleaning step. In the former, A=2.3×10⁻⁴ nm/sec/wt % and v=1.4×10⁻³ nm/sec. In the latter, A=0.044 nm/sec/wt % and v=0.28 nm/sec. From these, the allowable etching amount becomes 24.4+24.4=48.8 nm. Then, the total chemical etching amount of the major surface of the sample substrate by the second processing step and cleaning step is 2.6 nm+16.5 nm=19.1 nm, which is <48.8 nm, and expression (1) is satisfied. The sample substrate after the implementation of procedure 7 was measured for striae-originated MSFR of the major surface according to the MSFR measuring step described above, as a result, MSFR was 9.8 nm, confirming that the surface roughness is prevented from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 2.

### Example 8

The procedure was the same as in Example 5 except that the sample substrate has a striae-originated MSFR (MSFR₀) of the major surface after pre-polishing of 8.4 nm and a TiO₂ concentration distribution (ΔTiO₂) in the major surface of 0.16 wt %. Potassium hydroxide is used as the dispersion medium for the abrasive in the second processing step, and an aqueous 0.3% hydrofluoric acid solution is used as the cleaning solution in procedure 3 of the cleaning step. In the former, A=2.3×10⁻⁴ nm/sec/wt % and v=1.4×10⁻³ nm/sec. In the latter, A=0.044 nm/sec/wt % and v=0.28 nm/sec. From these, the allowable etching amount becomes 61.7+61.7=123.4 nm. Then, the total chemical etching amount of the major surface of the sample substrate by the second processing step and cleaning step is 2.6 nm+2.8 nm=5.4 nm, which is <123.4 nm, and expression (1) is satisfied.

The sample substrate after the implementation of procedure 7 was measured for striae-originated MSFR of the major surface according to the MSFR measuring step described above, as a result, MSFR was 8.6 nm, confirming that the surface roughness is prevented from deterioration due to implementation of the finishing. When the defect in the major surface of the sample substrate after the implementation of procedure 7 was evaluated using a defect inspector (M7360 of Lasertec Corporation), the number of defects with a size of 50 nm or more was 4.

### Example 9

The procedure was the same as in Example 5 except that the sample substrate has a striae-originated MSFR (MSFR₀) of the major surface after pre-polishing of 7.3 nm and a TiO₂ concentration distribution (ΔTiO₂) in the major surface of 0.12 wt %. Potassium hydroxide is used as the dispersion medium for the abrasive in the second processing step, and an aqueous 0.3% hydrofluoric acid solution is used as the cleaning solution in procedure 3 of the cleaning step. In the former, A=2.3×10⁻⁴ nm/sec/wt % and v=1.4×10⁻³ nm/sec. In the latter, A=0.044 nm/sec/wt % and v=0.28 nm/sec. From these, the allowable etching amount becomes 140.3+140.3=280.6 nm. Then, the total chemical etching amount of the major surface of the sample substrate by the second processing step and cleaning step is 2.6 nm+2.8 nm=5.4 nm, which is <280.6 nm, and expression (1) is satisfied.

The sample substrate after the implementation of procedure 7 was measured for striae-originated MSFR of the major surface according to the MSFR measuring step described above, as a result, MSFR was 7.4 nm, confirming that the surface roughness is prevented from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 3.

### Example 10

The procedures were the same as in Example 8 except that the first processing step was carried out by the following procedure.

### (First Processing Step)

The entire major surface of the sample substrate after pre-polishing was processed by a rotary small processing tool. The processing conditions were:

polishing site: 20 mmφ,

abrasive: cerium oxide with an average particle diameter (D50) of 2 μm,

polishing pad: soft pad (Bellatrix N7512 manufactured by Filwel, Co., Ltd.),

rotation rate of polishing part: 400 rpm,

polishing pressure: 2.5 g-weight/mm², and

processing time: 40 minutes.

MSFR₀ obtained in the MSFR measuring step is 8.4 nm, and ΔTiO₂ obtained in the TiO₂ concentration distribution measuring step is 0.16 wt %. In addition, potassium hydroxide is used as the dispersion medium for the abrasive in the second processing step, and an aqueous 0.3% hydrofluoric acid solution is used as the cleaning solution in procedure 3 of the cleaning step. In the former, A=2.3×10⁻⁴ nm/sec/wt % and v=1.4×10⁻³ nm/sec. In the latter, A=0.044 nm/sec/wt % and v=0.28 nm/sec. From these, the allowable etching amount is 61.7+61.7=123.4 nm. Then, the total chemical etching amount of the major surface of the sample substrate by the second processing step and cleaning step is 2.6 nm+2.8 nm=5.4 nm, which is <123.4 nm, and expression (1) is satisfied.

The sample substrate after the implementation of procedure 7 was measured for striae-originated MSFR of the major surface according to the MSFR measuring step described above, as a result, MSFR was 8.6 nm, confirming that the surface roughness is prevented from deterioration due to implementation of the finishing. When the defect in the major surface of the sample substrate after the implementation of procedure 7 was evaluated by using a defect inspector (M7360 of Lasertec Corporation), the number of defects with a size of 50 nm or more was 4.

The present invention has been described in detail with reference to specific embodiments thereof, but it will be apparent to a person skilled in the art that various changes and modifications can be made without departing from the spirit and scope of the present invention.

The present application is based on Japanese Patent Application No. 2014-251922 filed on Dec. 12, 2014 and Japanese Patent Application No. 2015-158240 filed on Aug. 10, 2015, the contents of which are incorporated herein by reference.

What is claimed is:

1. A method of finishing a pre-polished TiO₂—SiO₂ glass substrate, comprising:
an MSFR measuring step of measuring a striae-originated MSFR (MSFR₀) of a major surface of the pre-polished TiO₂—SiO₂ glass substrate,
a TiO₂ concentration distribution measuring step of measuring a TiO₂ concentration distribution (ΔTiO₂) in the major surface of the pre-polished TiO₂—SiO₂ glass substrate,
a first processing step of processing the major surface of the pre-polished TiO₂—SiO₂ glass substrate by using a local processing tool with a unit processing area being smaller than the area of the major surface of the pre-polished TiO₂—SiO₂ glass substrate,
a second processing step of processing the major surface of the TiO₂—SiO₂ glass substrate after the implementation of the first processing step, by a chemical-mechanical polishing using a polishing pad and a polishing slurry containing an abrasive and an acidic or alkaline dispersion medium, and
a cleaning step of cleaning the major surface of the TiO₂—SiO₂ glass substrate after the implementation of the second processing step, by using an acidic or alkaline cleaning solution, wherein
according to the MSFR₀ (nm) determined in the MSFR measuring step and the ΔTiO₂ (wt %) determined in the TiO₂ concentration distribution measuring step, the total etching amount (nm) of a chemical etching amount of the major surface of the TiO₂—SiO₂ glass substrate by the acidic or alkaline dispersion medium used in the second processing step and another chemical etching amount of the major surface of the TiO₂—SiO₂ glass substrate by the acidic or alkaline cleaning solution used in the cleaning step is controlled to satisfy the following expression (1):
Total etching amount≦(10 nm−MSFR₀)v/A/ΔTiO₂ (1)
(in expression (1), v is an average etching rate (nm/sec) of the TiO₂—SiO₂ glass substrate, and A is an TiO₂ concentration dependency (nm/sec/wt %) of an etching rate of the TiO₂—SiO₂ glass substrate).

2. The method of finishing a pre-polished TiO₂—SiO₂ glass substrate according to claim 1, wherein the polishing slurry used in the second processing step comprises a colloidal silica as the abrasive and the acidic dispersion medium.

3. The method of finishing a pre-polished TiO₂—SiO₂ glass substrate according to claim 1, wherein the polishing slurry used in the second processing step comprises a colloidal silica as the abrasive and the alkaline dispersion medium.

4. The method of finishing a pre-polished TiO₂—SiO₂ glass substrate according to claim 1, wherein the cleaning solution used in the cleaning step comprises any one alkaline cleaning solution selected from the group consisting of ammonia, sodium hydroxide, potassium hydroxide, an alkaline detergent, and tetramethylammonium hydroxide.

5. The method of finishing a pre-polished TiO₂—SiO₂ glass substrate according to claim 1, wherein the cleaning solution used in the cleaning step comprises any one acidic cleaning solution selected from the group consisting of hydrofluoric acid and silicofluoric acid.

6. A TiO₂—SiO₂ glass substrate having a TiO₂ concentration of from 3 mass % to 14 mass %, a TiO₂ concentration distribution (ΔTiO₂) in a major surface of the TiO₂—SiO₂ glass substrate of 0.21 mass % or less, and a striae-originated MSFR of the major surface of the TiO₂—SiO₂ glass substrate of 10 nm or less.

7. A method of measuring a TiO₂ concentration distribution in a major surface of a TiO₂—SiO₂ glass substrate, comprising:
measuring a striae-originated MSFR (MSFR₀) of the major surface of the TiO₂—SiO₂ glass substrate,
etching the major surface by 2 nm or more in terms of an etching amount,
measuring another striae-originated MSFR (MSFR₁) in the major surface after the etching, and
determining the TiO₂ concentration distribution (ΔTiO₂) in the major surface of the TiO₂—SiO₂ glass substrate from an MSFR increment (ΔMSFR (MSFR₁−MSFR₀)) caused by the etching.

8. A TiO₂—SiO₂ glass substrate having a TiO₂ concentration of from 3 mass % to 14 mass % and a TiO₂ concentration distribution (ΔTiO₂) in a major surface of the TiO₂—SiO₂ glass substrate measured by the method described in claim 7 of 0.21 mass % or less.
